(19) United States
(12) Patent Application Publication
(10) Pub. No.: US 2004/0265598 A1
(43) Pub. Date: Dec. 30, 2004

(54) Coating and method of coating a zinc containing substrate

(76) Inventors: Mohan Sanduja, Flushing, NY (US); Carl Horowitz, Brooklyn, NY (US); Ella Mayslich, Brooklyn, NY (US); Paul Thottathil, New Hyde Park, NY (US)

Correspondence Address: KENYON & KENYON, ONE BROADWAY, NEW YORK, NY, 10004, US

(21) Appl. No.: 10/607,254

(22) Filed: Jun. 25, 2003

(51) Int. Cl. C08G 18/00; B32B 27/00; B32B 27/40; B32B 15/04; C08G 77/00

(52) U.S. Cl. 428/425.8; 428/457; 528/44; 528/10

(57) ABSTRACT

A finish is disclosed for a zinc-containing substrate where the finish is a film that is chemically grafted onto the zinc-containing substrate. The film is highly anticorrosive and abrasion resistant and capable of providing an appearance that mimics finishes such as chrome, gold or brass. The film is formed when a coating comprising of a monomer, prepolymer and silver ion graft initiator is applied to the zinc-containing substrate.

### FIELD OF INVENTION

The present invention relates to finishes for articles of manufacture, and more particularly, decorative films for zinc-containing substrates that possess a high level of protection against corrosion and abrasion. The film is capable of providing an appearance that mimics known finishes such as chrome, gold or polished brass. The finish of the present invention, however, is more durable than conventional coatings or platings because the finish of the present invention is chemically grafted to the zinc-containing substrate.

### BACKGROUND TO THE INVENTION

There are many different types of finishes that can be applied to a substrate. Some finishes are purely decorative while others are applied to attain certain performance standards. Finishes can be physically or chemically bonded to the surface of a substrate. Chemical bonds are much stronger than physical bonds, and chemically bonded finishes have a lower tendency to be removed by abrasion and wear. Chemically bonding polymeric materials to a substrate is known as chemical grafting, as described in U.S. Pat. Nos. 5,232,748 and 3,401,049. These patents describe grafting a polymeric finish onto non-metallic substrates in steps that include pre-activating the substrate and applying a polymeric coating. These patents describe using heat, lasers and microwaves to accelerate the polymerization and cure.

For zinc in particular, there are several types of finishes. Conventionally, in order for finishes for zinc-containing substrates to protect of the substrate and achieve specified decorative colors, methods like electroplating, physical vapor deposition (PVD) or painted coatings such as epoxy, lacquer, enamel or acrylic are used. Unprotected zinc-containing substrates will tarnish quickly, affecting appearance. In electroplating, a metal is deposited on the surface of an article by placing the article to be plated in a bath containing a metallic salt solution such as nickel or chrome and the article is negatively charged. Through the ionization of the metal salt in the bath, a physical bond is formed between the metal and the article to be plated.

However, there are several problems with electroplating. Often the article must undergo expensive buffing or polishing before the electroplating process in order to achieve the desired appearance. Zinc-containing substrates generally must be plated with at least a protective layer of copper, called a copper strike, in order to fill in the pores and to smooth the surface of the zinc-containing substrate. Because of zinc's porosity, most conventional finishing methods require some type of pre-sealing step before a conventional finish can be applied to zinc. After the zinc-containing substrate is sealed with the copper strike, it must be plated with a layer of nickel before a layer of chrome can be added by known technologies. The differences between the metal in the plating and the metal in the substrate can lead to corrosion, and minute defects in the chrome plating can lead to white rust and corrosion blisters. As plated coatings are generally porous, moisture on the plated coating can lead to corrosion of the substrate. Because electroplating attaches a coating to a substrate by a physical bond, the coatings are susceptible to removal by abrasion when used by consumers. Furthermore, known chrome plating processes require the use of chemicals like hexavalent chrome and cyanide solutions, which are extremely toxic, known carcinogens and highly regulated. The zinc-containing substrates must also undergo an extensive cleaning process before plating even can begin.

PVD is a technique that uses various power sources like evaporation, lasers or sputtering to form a vapor of the material to be deposited on an article as a thin film. As described in U.S. Pat. No. 6,245,435, PVD methods can achieve specific decorative colors such as gray, gold or black, but are conventionally used to obtain a hard clear finish on a substrate. Without the need for the same toxic chemicals, PVD by itself can be more environmentally friendly than electroplating.

However, PVD only provides a physical bond to the substrate that is not as strong as a chemical bond. Because of the physical bond, the coating is subject to removal by abrasion. To prevent corrosion on zinc, a current practice is to electroplate the zinc-containing substrate with an anti-corrosive material before depositing the outer coating by PVD, but this introduces many of the environmental problems encountered in electroplating. In the case of decorative coatings, which are generally soft and have little resistance to abrasion or corrosion, a substrate will have to be coated with a layer of protective materials as well as the layer of decorative materials in order to be made corrosion and abrasion resistant. PVD also requires that the surface of the substrate be free from defects.

PVD poses a special problem for zinc die-castings and other porous surfaces. The heat and pressure used in PVD could lead to trapped gas in the pores beneath the PVD applied coating. The gas can work its way through the protective layers, creating a pathway to corrosion. Another disadvantage of PVD methods is that process requires the coating to be done in small batches, which coupled with the specialized equipment and the huge amount of scrap and waste produced, make the process prohibitively expensive.

For painted on coatings, specific decorative colors may be achieved along with specified surface characteristics like corrosion protection. However coating thickness must be stringently controlled and the coating still only involves a physical bond. Such a coating can be removed by abrasion. Drying the painted on coatings often involves releasing volatile organic compounds, which are strictly regulated environmental hazards.

Thus, there exists a need for a chemically bonded finish for a zinc-containing substrate that can deliver specific decorative colors and meets or exceeds industry requirements for factors including but not limited to corrosion, abrasion, and humidity blistering. The finish should be applicable in one step, and the process must not entail the expense or environmental problems of conventional methods.

### SUMMARY OF THE INVENTION

The present invention overcomes these many problems of known methods and of coatings for zinc-containing substrates. Specifically, the finish of the present invention can provide a chemically bonded, corrosion and abrasion resistant film capable of providing a multitude of appearances to the zinc-containing substrate such as color, shine and reflectiveness. The finish can be applied in one step, and the expense and hazards associated with the conventional coatings are greatly reduced.

The finish is a film that is chemically bonded to the zinc-containing substrate. To produce the film, a coating comprised of a prepolymer, a monomer and a silver ion serving as a graft initiator is applied to the zinc-containing substrate. Peroxide catalysts and solvents may be added to the coating, and colorants such as dyes or pigments may also be added to achieve a desired appearance. Upon applying the coating to the zinc-containing substrate, the coating may form a corrosion resistant film that does not bubble, crack or give rise to other failures that expose the zinc-containing substrate to environmental conditions. The film may protect the zinc-containing substrate from abrasion caused by grit or sand, wear caused by metal to metal or other contact, chemical penetration and scratching. In addition to the performance properties, the film may also give the zinc-containing substrate a specific decorative appearance such as brass, chrome or other colors.

The coating does not have to be heated in order to for the film to form. Conventionally, either the coating or the substrate must be heated in order for chemical grafting to take place on a metal surface. However, in the present invention, neither the coating nor the substrate needs to be heated, and the entire manufacturing process may take place at room temperature.

The monomers and prepolymers in the coating are selected so that the resultant film has a zero permeability to oxygen and other corrosive gases and zero water transmission. Preferably, vinyl monomers and urethane prepolymers with one or more functional groups such as hydroxy, carboxyl, or glycidyl groups are used in the coating. Preferably, a functional group is what allows the monomer and prepolymer to form covalent bonds with the polymer. The more functional groups present, the more potentially available sites there are for bonding.

The film finished zinc-containing substrates are used in applications such as door and faucet hardware, and are subject to impact, wear and tear, perspiration from human skin and other environmental conditions. The articles may also be used in conjunction with other pieces of equipment. The Builders Hardware Manufactures Association (BHMA), the American Society of Mechanical Engineers (ASME), the American Society for Testing and Materials (ASTM) and the International Association of Plumbing and Mechanical Officials (IAPMO) set forth the industry accepted performance guidelines for items in the plumbing, building and lock hardware industries. These guidelines are incorporated by reference.

In order to ensure that the finished product will withstand the consumer environment, the film may be manufactured to meet or exceed the finish performances listed in Table 1. The finish performances of the film may exceed the minimum performances required by the testing standards and are not meant to limit the scope of the invention in any way.

TABLE 1
FINISH PERFORMANCE

| | | | SPECIFIC |
|---|---|---|---|
| | | | REFERENCE FOR |
| | | INDUSTRY | REQUIRED MINIMUM |
| PROPERTY TESTING | FINISH | STANDARD | FINISH |
| STANDARD | PERFORMANCE | (BHMA/IAPMO) | PERFORMANCE |
| Corrosion: | | | |
| ASTM B117-95 | 1000 hrs | 96 hrs | BHMA A156.18 (section |
| | | | 3.2) |
| ASTM B368-85 | 96 hrs | 96 hrs | BHMA A156.18 (section |
| | | | 3.9) |
| Humidity: | | | |
| BHMA A156.18 (section | 1000 | 240 hrs | BHMA (A.156.18 (section |
| 3.3) | | | 3.3) |
| Pencil Hardness: | | | |
| BHMA A156.18 (section | 6 hrs | 4 hrs | BHMA A156.18 (section |
| 3.4) | | | 3.4) |
| Abrasion Resistance: | | | |
| ASTM D4060-95 (Taber) | 1000 cycles | 500 cycles | BHMA A156.18 (section |
| | | | 3.8) |
| ASTM D968-93 (Method | Method A-12 L of | Method A-12 L of | BHMA A156.18 (section |
| A) | silica sand on flat | silica sand on flat | 3.6) |
| | surface of specimen | surface of specimen | BHMA A112.18.1 |
| | | | (section 4.2.3.5) |
| UV/Condensation: | | | |
| ASTM G53-96 | 500 hrs | 144 hrs | BHMA A156.18 (section |
| | | | 3.7) |
| Perspiration Test: | | | |
| BHMA A156.18 (section | 4 cycles | 4 cycles | BHMA A156.18 (section |
| 3.5) | | | 3.5) |
| Water Degradation: | | | |
| ASME A112.18.1 | Examined as stated | Examined as stated | ASME A112.18.1 (section |
| | in standard | in standard | 4.2.3.2) |
| Adhesion: | | | |
| ASTM D3359-02 (Method | Examined as stated | Examined as stated | ASME A112.18.1-3 |
| A) | in standard | in standard | (section 4.2.3.4) |
| ASTM B571-97e1 | Examined as stated | Examined as stated | ASME A112.18.1 (section |
| | in standard | in standard | 4.2.1-b) |
| Soap and Cleaner Effects: | | | |
| ASME A112.18.1 | Examined as stated | Examined as stated | ASME A112.18.1 (section |
| | in standard | in standard | 4.2.3.3) |

Materials are subjected to harsh testing just to meet the minimum of these industry standards. For example, the corrosion resistance test ASTM B117-95 subjects an item to 96 hours of a salt spray and afterwards the item must not have more than one spot of corrosion greater than 1.6 mm in diameter. The present invention may subject the film on the zinc-coated substrate to the corrosive environment for a much longer period of time and may require no more corrosion to be present than in the shorter test.

Chemical grafting chemically bonds the film to the zinc-containing substrate. Chemical grafting can be visualized as the growth of whiskers onto a material. Without being bound by theory, it is believed that in the presence of ambient moisture there is a layer of oxide and hydroxyl bound to the surface of the zinc-containing substrate. These oxides and hydroxyl groups can be removed by the graft initiator to form a highly reactive radical that reacts with the prepolymers and monomers to start polymerization.

Because of its surface chemistry, zinc is especially difficult to chemically graft. A Silver ion, preferably silver perchlorate, can overcome these difficulties to form a radical and begin the reaction. The monomers and pre-polymers that bond to zinc are selected based on their ability to adhere to zinc. Because of the porous nature of zinc, the monomers and prepolymers are preferably small in size so that grafting can take place in the pores and fully coat the zinc-containing substrate. This way, zinc-containing substrates of various shapes and sizes can be finished with the film.

While chemical grafting can be visualized as the growth of whiskers onto a substrate, conventionally, the formation of whiskers on zinc has been discouraged. As whiskers grow, there is the enhanced probability that the whiskers will break off and contaminate surrounding equipment. U.S. Pat. No. 5,730,851 describes a method to reduce and prevent whiskers on zinc. Since the monomers and pre-polymers are selected based on their ability to adhere to zinc, the whiskers that may be formed in the present invention are surprisingly durable. Hence, the likelihood of whiskers in the present invention breaking off and contaminating surrounding equipment is lowered.

The mechanism of graft polymerization may be represented as the following where GI represents the graft initiator and ZnO represents the highly reactive radical:

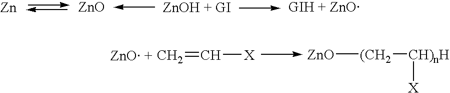

Various coatings have been grafted onto different types of substrates. U.S. Pat. No. 5,429,969 describes a reactive coating of polymers and monomers on wood. Other patents such as U.S. Pat. Nos. 4,105,811 and 5,013,266 describe grafting polymerized coatings onto metals such as aluminum and steel. However, none of these patents describe the performance or appearance of the present invention. In particular, these patents neither describe nor suggest the high degree of protection from corrosion, abrasion and humidity of the present invention, nor do they describe or suggest a such a film with the decorative appearance on a zinc-containing substrate as taught in the present invention.

### DESCRIPTION OF THE PREFERRED EMBODIMENTS

In a preferred embodiment, the coating is prepared by taking a requisite amount of one or a combination of prepolymers capable of adhering to zinc in a container and adding one or a combination monomers capable of adhering to zinc along with a silver ion graft initiator. Silicone polyester prepolymers may also be used in the coating. Preferably vinyl monomers and urethane prepolymers are used.

In another embodiment, the coating is prepared by taking prepolymers and monomers capable of adhering to zinc and adding solvents, catalyst, silver ion graft initiator and dye in the order listed in the Examples. In another embodiment, combinations of several monomers alone or in conjunction with pre-polymers may also be used. A small amount of catalyst, preferably a peroxide, may be added to the coating to accelerate the reaction by regenerating the silver ion graft initiator and providing more free reactive radicals. The contents of the coating may be stirred to a uniform solution at room temperature. The monomer is preferably present within the range of about 0.5-6.3 parts by weight. The prepolymer is preferably present within the range of about 4.6-63 parts by weight. The graft initiator is preferably present in about 0.1 parts by weight.

The zinc-containing substrate should contain more than a trace amount of zinc, and the substrate may be a zinc-die cast, a zinc-coated surface or other zinc-containing article. The zinc-containing substrate should be oil and dust free before the coating is applied. The coating may be applied by dipping, spraying or any other conventional application method. Defoaming or leveling agents may be added to the coating in order to best facilitate the application method. The film formed on the zinc-containing substrate is then dried. During drying, moisture and solvents may be evaporated from the film. In a preferred embodiment, the film is air dried for about 10 to 15 minutes. In another preferred embodiment, heat is used to accelerate the drying process.

In another embodiment, a curing agent is included in the coating. After the film dries on the zinc-containing substrate, the article may be cured. However, curing may take place without a curing agent and may be concurrent with drying. The article may be cured at air temperature or at another temperature below the melting point of the zinc-containing substrate.

In another embodiment, a pigment is included instead of a dye in order to give the article a specific decorative color. The pigment may need to be milled before the pigment is added to the coating. The milling may be performed using a ball roll mill or other conventional method to reduce the particle size of the pigment so that the particles may be dissolved in the coating. A filter may also be used to provide the appropriate pigment particle size.

In an embodiment for a commercial setting, the coating would contain monomers and prepolymers capable of adhering to zinc and capable of producing a film with zero permeability to oxygen and zero water transmission. Solvents, catalyst, a silver ion graft initiator and colorants in the form of dyes or pigments would be mixed in a 55-gallon drum in the order listed in the Examples below. Preferably the coating would not be mixed far in advance of the production run. The shelf life of the coating may be about 90 days and could be stored in sealed containers to prevent degradation.

The zinc-containing substrate should be oil and dust free before applying the coating and may undergo a pretreatment to remove any dirt or oil than could interfere with applying the coating or the appearance of the film. The zinc-containing substrate could be buffed and polished as a pretreatment. Also the substrate could be washed in a mixture that contains soapy water, deionized water or other appropriate solution. The wash mixture could be subject to ultrasound to further clean the substrate. After the wash, the zinc-containing substrate could be air-dried.

The coating could then be applied to the substrate by atomizing the coating and using compressed air to spray the coating onto the substrate. The substrate could be electrostatically enhanced to promote good spray coverage on the substrate. A rack, conveyor system, or other conventional means could be used to hold the zinc-substrate in place during the manufacturing process. The rack may also be electrostatically enhanced to promote good spray coverage.

After spraying, the article could be dried and cured. While both curing and drying can take place at room temperature, the processes may be accelerated with temperature. The item could be dried for about 1 to 3 minutes and cured for about 10 to 12 minutes at about 300-350F. Afterwards, the article would be cooled down and taken off the rack to be tested. In this embodiment the entire process would take about 20 to 30 minutes.

For illustrative purposes only, the following examples set forth coatings that may be contacted with the zinc-containing substrate to produce a film with enhanced protective properties and that give the substrate a specific decorative color. The names of commercial products are used for illustrative purposes only and are not intended to limit the scope of the invention.

### EXAMPLE 1

Bright Chrome

| INGREDIENT | PARTS BY WEIGHT |
|---|---|
| Silicone Polyester Prepolymer | 60.00 |
| Chempol 206-9460 | |
| Cellosolve Acetate 92.0} | 8.00 |
| N Butanol 8.0} | |
| Methyl Ethyl Ketone (MEK) | 20.00 |
| Monomer Coatosil 3573 | 0.30 |
| Monomer Silane A174 | 1.00 |
| Zapon Blue 807 (10% in MEK) | 1.00 |
| Brilliant Violet S-3RL | 0.20 |
| (10% MEK) | |
| Silver Perchlorate (0.1% in MEK) | 0.10 |
| Methyl Ethyl Ketone Peroxide | 0.05 |

### EXAMPLE 2

Bright Chrome

| INGREDIENT | PARTS BY WEIGHT |
|---|---|
| Silicone polyester prepolymer | 4.20 |
| Chempol 206-9460 | |
| Polyester prepolymer | 0.14 |
| Chempol 011-2339 | |
| Cellosolve acetate 92.0 | 0.70 |
| N Butanol 8.0 | |
| Methyl Ethyl Ketone | 70.00 |
| PM Acetate | 24.00 |
| Pigment Metalure L55700 | 25.00 |
| Monomer Silane A174 | 6.06 |
| Monomer Coatosil 1211 | 0.10 |
| Benzoyol peroxide | 0.10 |
| (0.01% in MEK) | |
| Silver perchlorate | 0.10 |
| (0.1% in MEK) | |

### EXAMPLE 3

Aluminum Gray

| INGREDIENT | PARTS BY WEIGHT |
|---|---|
| Alkyd Ester Prepolymer | 27.00 |
| Kelsol 3964 B26-70 | |
| Butyl Cellusolve | 23.50 |
| PM Solvent | 3.00 |
| Melamine Prepolymer Cylmel 303 | 6.00 |
| Eternabrite EBP251PA | 6.00 |
| Monomer Sartomer 252 | 1.00 |
| Monomer Silane A187 | 1.00 |
| Benzoyl Peroxide (0.01% in MEK) | 0.10 |
| Silver Perchlorate (1% in MEK) | 0.10 |

### EXAMPLE 4

Yellow

| | PARTS BY |
|---|---|
| INGREDIENTS | WEIGHT |
| Silicone Polyester Prepolymer | 60.00 |
| Chempol 206-9460 8.0 | |
| Cellosolve Acetate 92.0 | 8.50 |
| N-Butanol 8.0 | |
| Polyester Prepolymer Chempol | 2.50 |
| 011-2339 | |
| PM Acetate | 31.50 |
| Monomer Silane A174 | 1.00 |
| Monomer Coatosil 3573 | 0.30 |
| Methyl Ethyl Ketone Peroxide | 21.70 |
| Neozapon Yellow 115 (8% in MEK) | 5.00 |
| Neozapon Red 365 (2% in MEK) | 11.00 |
| Methyl Ethyl Ketone | 0.10 |
| Peroxide (0.1% in MEK) | |
| Silver Perchlorate | 0.10 |
| (0.1% in MEK) | |

### EXAMPLE 5

Gold

| INGREDIENTS | PARTS BY WEIGHT |
|---|---|
| Silicone Polyester Prepolymer | 60.00 |
| Chempol 206-9460 | |
| PM Acetate | 65.00 |
| Polyester Prepolymer | 2.50 |
| Chempol 011-2339 | |
| Monomer Silane A174 | 1.00 |
| Monomer Coatosil 3573 | 0.30 |
| Monomer Coat-o-sil 1211 | 0.30 |
| Methyl Ethyl Ketone | 5.00 |
| Zapon Yellow 141 (2.5% in MEK) | 15.00 |
| Sudan Orange 220 (5% in MEK) | 1.00 |
| Neozapon Red 365 (2% in MEK) | 5.00 |
| Benzoyl Peroxide (0.01% in MEK) | 0.10 |
| Silver Perchlorate (0.1% in MEK) | 0.10 |

It will be apparent to those skilled in the art that various modifications can be made in the present invention without deviating from the scope or spirit of the invention. Thus, it is intended that the present invention covers modifications and variations of this invention provided that these come within the scope of the following or their equivalents.

What is claimed is:

1. A coating for chemically grafting a film onto a zinc-containing substrate comprising:
a prepolymer capable of adhering to zinc;
a monomer capable of adhering to zinc;
a silver ion graft initiator.

2. The coating of claim 1, further comprising a peroxide catalyst.

3. The coating of claim 1 wherein the monomer is a vinyl monomer.

4. The coating of claim 1 wherein the prepolymer is a urethane prepolymer.

5. The coating of claim 1 wherein the silver ion graft initiator is silver perchlorate.

6. The coating of claim 1 wherein the coating further comprises a dye.

7. The coating of claim 1 wherein the coating further comprises a curing agent.

8. The coating of claim 1 wherein the coating further comprises a pigment.

9. The coating of claim 1 wherein the monomer is present at a range of about 0.5-6.3 parts by weight.

10. The coating of claim 1 wherein the prepolymer is present at a range of about 4.6-63 parts by weight.

11. The coating of claim 1 wherein the silver ion graft initiator is present at about 0.10 parts by weight.

12. A coating for chemically grafting a film onto a zinc-containing substrate comprising:
a urethane prepolymer capable of adhering to zinc;
a vinyl monomer capable of adhering to zinc;
a silver perchlorate ion graft initiator;
a curing agent;
a peroxide catalyst; and
a dye.

13. A coating for chemically grafting a film onto a zinc-containing substrate comprising:
a urethane prepolymer capable of adhering to zinc;
a vinyl monomer capable of adhering to zinc;
a silver perchlorate ion graft initiator;
a curing agent;
a peroxide catalyst; and
a pigment.

14. A coating for chemically grafting a film onto a zinc-containing substrate comprising:
60.00 parts by weight Silicone Polyester Prepolymer Chempol 206-94;
65.00 parts by weight PM Acetate;
2.50 parts by weight Polyester Prepolymer Chempol 011-2339;
1.00 parts by weight Monomer Silane A174;
0.30 parts by weight Monomer Coatosil 3573;
0.30 parts by weight Monomer Coatosil 1211;
5.00 parts by weight Methyl Ethyl Ketone;
15.00 parts by weight Zapon Yellow 141 (2.5% in MEK);
1.00 parts by weight Sudan Orange 220 (5% in MEK);
5.00 parts by weight Neozapon Red 365 (2% in MEK);
0.10 parts by weight Benzoyl Peroxide (0.01% in MEK); and
0.10 Silver Perchlorate (0.1% in MEK).

15. A coating for chemically grafting a film onto a zinc-containing substrate comprising:
4.20 parts by weight Silicone polyester prepolymer Chempol 206-9460;
0.14 parts by weight Polyester prepolymer Chempol 011-2339;
0.70 parts by weight Cellosolve acetate 92.0 and N Butanol 8.0;
70.00 parts by weight Methyl Ethyl Ketone;
24.00 parts by weight PM Acetate;
25.00 parts by weight Pigment Metalure L55700;
6.06 parts by weight Monomer Silane;
0.10 Monomer Coatosil 1211;
0.10 Benzoyol peroxide (0.01% in MEK); and
0.10 Silver perchlorate (0.1% in MEK).

16. A method for chemically grafting a film onto a zinc-containing substrate comprising:
providing a zinc-containing substrate;
providing a coating, wherein the coating includes,
a prepolymer with suitable adhesion to zinc,
a monomer with suitable adhesion to zinc;
a silver ion graft; and
applying the coating to the zinc-containing substrate.

17. The method of claim 16 further comprising drying the coating onto the zinc-containing substrate.

18. The method in claim 17 wherein the coating is air-dried on the zinc-containing substrate.

19. The method of claim 16 wherein the coating is applied at room temperature to the zinc-containing substrate.

20. The method of claim 16 wherein the zinc-containing substrate is at room temperature.

21. The method of claim 16 further comprising curing the coating onto the zinc-containing substrate.

22. The method in claim 21 wherein the curing takes place at room temperature.

23. The method of claim 16 wherein providing the coating further comprises selecting the prepolymer such that the film has zero oxygen permeability and zero water transmission.

24. The method of claim 16 wherein providing the coating further comprises selecting the monomer such that the film has zero oxygen permeability and zero water transmission.

25. The method in claim 16 wherein the monomer is a vinyl monomer.

26. The method of claim 16 wherein the prepolymer is a urethane prepolymer.

27. The method of claim 16 wherein the graft initiator is silver perchlorate.

28. The method of claim 16 wherein the coating further comprises a dye.

29. The method of claim 16 wherein the coating further comprises a curing agent.

30. The method of claim 16 wherein the coating further comprises a pigment.

31. The method of claim 16 wherein providing the zinc-containing substrate further comprises buffing and polishing the substrate.

32. The method of claim 31 wherein providing the zinc-containing substrate further comprises subjecting the zinc-containing substrate to a wash mixture.

33. The method of claim 32 wherein the wash mixture is subjected to ultrasound.

34. A method for chemically grafting a film onto a zinc-containing substrate comprising:
providing a zinc-containing substrate, wherein the substrate has been buffed and polished and subjected to a wash mixture that is subjected to ultrasound;
selecting a urethane prepolymer capable of adhering to zinc and a vinyl monomer capable of adhering to zinc such that the film has zero oxygen permeability and zero water transmission;
applying a coating at room temperature, wherein the coating comprises,
the urethane prepolymer capable of adhering to zinc,
the vinyl monomer capable of adhering to zinc,
a silver perchlorate graft initiator,
a peroxide catalyst,
a curing agent, and
a dye;
air drying the coating onto the zinc-containing substrate; and
curing the coating onto the zinc-containing substrate at room temperature.

35. A method for chemically grafting a film onto a zinc-containing substrate comprising:
providing a zinc-containing substrate, wherein the substrate has been buffed and polished and subjected to a wash mixture that is subjected to ultrasound;
selecting a urethane prepolymer capable of adhering to zinc and a vinyl monomer capable of adhering to zinc such that the film has zero oxygen permeability and zero water transmission;
applying a coating at room temperature, wherein the coating comprises,
the urethane prepolymer capable of adhering to zinc,
the vinyl monomer capable of adhering to zinc,
a silver perchlorate graft initiator,
a peroxide catalyst,
a curing agent, and
a pigment;
air drying the coating onto the zinc-containing substrate; and
curing the coating onto the zinc-containing substrate at room temperature.

36. An article of manufacture comprising:
a zinc-containing substrate;
a film chemically bonded to the zinc-containing substrate,
wherein the film is corrosion and abrasion resistant, and
wherein the film comprises a polymerized monomer and prepolymer.

37. The article of claim 36 wherein the monomer is a vinyl monomer.

38. The article of claim 36 wherein the prepolymer is a urethane prepolymer.

39. The article of claim 36 wherein the film further comprises a dye.

40. The article of claim 39 wherein the article of manufacture has the appearance of chrome.

41. The article of claim 39 wherein the article of manufacture has the appearance of brass.

42. The article of claim 36 wherein the film further comprises a pigment.

43. The article of claim 42 wherein the article of manufacture has the appearance of chrome.

44. The article of claim 42 wherein the article of manufacture has the appearance of brass.

45. The article of claim 36 wherein the corrosion resistance meets at least 1000 hrs of ASTM B 117-95 corrosion resistance testing and where the abrasion resistance meets at least 1000 cycles of ASTM D4060-95 (Taber) abrasion testing.

46. The article of claim 36 wherein the film has zero oxygen permeability and zero water transmission.

47. An article of manufacture comprising:
a zinc-containing substrate;
a film chemically bonded to the zinc-containing substrate,
wherein the film is corrosion and abrasion resistant such that the film meets at least 1000 hrs of ASTM B 117-95 corrosion resistance testing and at least 1000 cycles of ASTM D4060-95 (Taber) abrasion testing,
wherein the film comprises a polymerized vinyl monomer and urethane prepolymer,
wherein the film further comprises a dye, and
wherein the film has zero oxygen permeability and zero water transmission; and
wherein the article of manufacture has the appearance of chrome.

48. An article of manufacture comprising:
a zinc-containing substrate;
a film chemically bonded to the zinc-containing substrate,
wherein the film is corrosion and abrasion resistant such that the film meets at least 1000 hrs of ASTM B 117-95 corrosion resistance testing and at least 1000 cycles of ASTM D4060-95 (Taber) abrasion testing,
wherein the film comprises a polymerized vinyl monomer and urethane prepolymer,
wherein the film further comprises a dye, and
wherein the film has zero oxygen permeability and zero water transmission; and
wherein the article of manufacture has the appearance of brass.

49. An article of manufacture comprising:
a zinc-containing substrate;
a film chemically bonded to the zinc-containing substrate,
wherein the film is corrosion and abrasion resistant such that the film meets at least 1000 hrs of ASTM B 117-95 corrosion resistance testing and at least 1000 cycles of ASTM D4060-95 (Taber) abrasion testing,
wherein the film comprises a polymerized vinyl monomer and urethane prepolymer,
wherein the film further comprises a pigment, and
wherein the film has zero oxygen permeability and zero water transmission; and
wherein the article of manufacture has the appearance of chrome.

50. An article of manufacture comprising:
a zinc-containing substrate;
a film chemically bonded to the zinc-containing substrate,
wherein the film is corrosion and abrasion resistant such that the film meets at least 1000 hrs of ASTM B117-95 corrosion resistance testing and at least 1000 cycles of ASTM D4060-95 (Taber) abrasion testing,
wherein the film comprises a polymerized vinyl monomer and urethane prepolymer,
wherein the film further comprises a pigment, and
wherein the film has zero oxygen permeability and zero water transmission; and
wherein the article of manufacture has the appearance of brass.
